(19) United States
(12) Patent Application Publication
(10) Pub. No.: US 2012/0060771 A1
(43) Pub. Date: Mar. 15, 2012

(54) HOT WATER HEATER SCHEDULER

(75) Inventors: Joseph Mark Brian, Louisville, KY (US); Michael Thomas Beyerle, Pewee Valley, KY (US); Jay Andrew Broniak, Louisville, KY (US); David C. Bingham, Louisville, KY (US)

(73) Assignee: General Electric Company

(21) Appl. No.: 12/898,767

(22) Filed: Oct. 6, 2010

(51) Int. Cl. F24H 9/20; H05B 1/02

(52) U.S. Cl. 122/14.1; 219/492

(57) ABSTRACT

A hot water heater and method for controlling same. The hot water heater can be programmed to only heat water when the consumer anticipates that they will need it. The consumer can control the temperature of the water, the time at which the hot water will be needed, and can specify the speed vs. efficiency tradeoff regarding how the water is heated by selecting an operating mode, for example, thereby resulting in a more energy efficient and cost effective hot water heater.

### BACKGROUND OF THE DISCLOSURE

The following disclosure relates to energy management, and more particularly to energy management of household consumer appliances, as well as other energy consuming devices and/or systems found in the home. The present disclosure finds particular application to a hot water heater.

Basic hot water heaters generally include a water reservoir, a heating element such as a gas or electric burner, and a thermostat that controls the burner to maintain a set temperature of the water in the reservoir. In general, the temperature of the water is maintained at a relatively constant level corresponding to a set point of the thermostat, for example 140 degrees F., until it is needed. As hot water is dispensed from the reservoir, cold water is admitted thereby lowering the temperature of the water. Once the temperature drops below the set point of the thermostat, the heating element is activated to raise the temperature of the water.

As will be appreciated, in many installations a water heater is used only a fraction of the time. For example, hot water demand in a residential installation may be greatest in the morning and then virtually non-existent during the day. Demand may then increase again in the evening. Conventional water heaters, however, work to maintain the set point temperature regardless of hot water demand. This can result in wasted energy during times of decreased demand.

### SUMMARY OF THE DISCLOSURE

A hot water heater that can be programmed to only heat water when the consumer anticipates that they will need it. The consumer can control the temperature of the water, the time at which the hot water will be needed, and can specify the speed vs. efficiency tradeoff regarding how the water is heated by selecting an operating mode, for example, thereby resulting in a more energy efficient and cost effective hot water heater.

Accordingly, a hot water heater comprises a reservoir for storing water, a heat source for selectively applying heat to the water, and a controller for controlling the heat source to optimize energy consumption of the water heater based on demand for hot water. The controller is configured to perform at least one of the following functions:
prevent the heat source from applying heat to the water during predetermined periods of time corresponding reduced demand;
activate the heat source prior to predetermined periods of increased demand;
select an operating mode; or
adjust a setpoint temperature of the water to be maintained by the application of heat by the heat source, including lowering the setpoint temperature when reduced demand is anticipated, and increasing the setpoint temperature when increased demand is anticipated.

The controller can be programmed to perform at least one of the functions at a user specified time and/or programmable to perform at least one function in accordance with a user defined schedule. The user defined schedule can be at least one of a weekly schedule, a monthly schedule or an annual schedule. A user interface can be provided for programming the controller to control the heat source. The heat source can include at least one of an electric heating element, a gas heating element or a heat exchanger heating element.

In accordance with another aspect, a device for controlling a heating element of a hot water heater comprises a controller for controlling the heat source to optimize energy consumption of the water heater based on demand for hot water. The controller is configured to perform at least one of the following functions:
prevent the heat source from applying heat to the water during predetermined periods of time corresponding reduced demand;
activate the heat source prior to predetermined periods of increased demand;
select an operating mode; or
adjust a setpoint temperature of the water to be maintained by the application of heat by the heat source, including lowering the setpoint temperature when reduced demand is anticipated, and increasing the setpoint temperature when increased demand is anticipated.

The controller can be programmed to perform at least one of the functions at a user specified time and/or to perform at least one function in accordance with a user defined schedule. The user defined schedule can be at least one of a weekly schedule, a monthly schedule or an annual schedule. A user interface for programming the controller to control the heat source can be provided. The heat source can include at least one of an electric heating element, a gas heating element, or a heat exchanger heating element.

In accordance with another aspect, a method of optimizing operation of a hot water heater including a heating source comprises controlling the heat source to optimize energy consumption of the water heater based on demand for hot water. The controlling includes at least one of:
preventing the heat source from applying heat to the water during predetermined periods of time corresponding reduced demand;
activating the heat source prior to predetermined periods of increased demand;
selecting an operating mode based on anticipated demand; or
adjusting a setpoint temperature of the water to be maintained by the application of heat by the heat source, including lowering the setpoint temperature when reduced demand is anticipated, and increasing the setpoint temperature when increased demand is anticipated.

The method can further comprise programming the controller to perform at least one of the functions at a user specified time and/or programming the controller to perform at least one function in accordance with a user defined schedule. The user defined schedule can include at least one of a weekly schedule, a monthly schedule or an annual schedule. The method can further comprise programming the controller via a user interface. The step of controlling the heat source can include controlling a current applied to an electric heat source, and/or controlling a run-time of a heat pump.

### BRIEF DESCRIPTION OF THE DRAWINGS

FIG. 1 is a schematic diagram of an exemplary hot water heater in accordance with the present disclosure.

FIG. 2 is a schematic diagram an exemplary user interface.

FIG. 3 is a schematic diagram of an exemplary hot water heater in a home energy management system in accordance with the present disclosure.

### DETAILED DESCRIPTION OF THE PREFERRED EMBODIMENTS

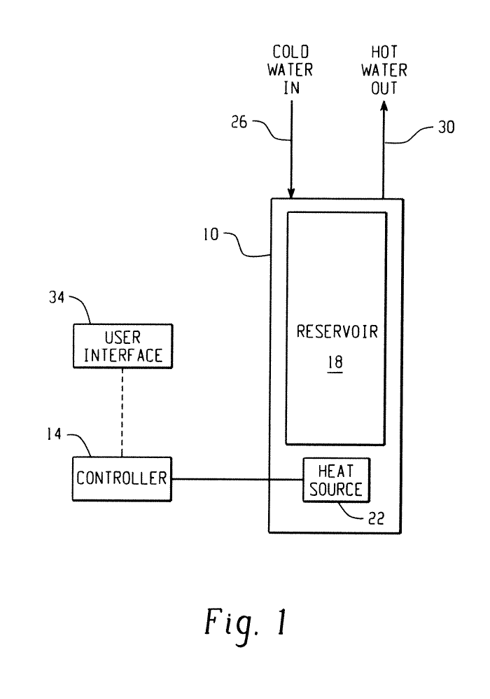

Turning now to the drawings, FIG. 1 illustrates a hot water heater 10 including a controller 14 in accordance with an exemplary embodiment of the present disclosure. The hot water heater 10 includes a reservoir 18 for storing water, and a heat source 22 for heating the water stored in the reservoir. A supply line 26 supplies water to the hot water heater 10 from a municipal supply, well, etc. Hot water outlet line 30 supplies hot water from the heater 10 to the pipes of a residence, for example, for supplying hot water to one or more plumbing fixtures.

In the illustrated embodiments, the specific details of the hot water heater construction have been omitted. It will be appreciated, however, that the hot water heater 10 can be any conventional hot water heater including an electric, gas, or hybrid hot water heater. Thus, the heat source 22 can be an electric heating element, such as a resistive-type heating element, a gas heating element, such as a propane or natural gas burner, a heat pump type heating element, or any other type of heating element.

In accordance with the present disclosure, the controller 14 is provided for controlling the heat source 22 to optimize energy consumption of the water heater based on demand for hot water. The controller 14 can be configured to, among other things, (i) prevent the heat source 22 from applying heat to the water during predetermined periods of time corresponding to reduced demand; (ii) activate the heat source prior to anticipated periods of increased demand; (iii) select an operating mode of the water heater; (iv) and/or adjust a setpoint temperature of the water to be maintained by the application of heat by the heat source, including lowering the setpoint temperature when reduced demand is anticipated, and increasing the setpoint temperature when increased demand is anticipated.

As will be appreciated, the controller 14 can be configured to carry out one or more of these functions at different times of the day, week, month, year, etc. For example, the controller can be programmable to perform at least one of the functions at a user specified time. A user interface 34 can be provided to enable the user to program the controller 14. The user interface 34 can include one or more user inputs and a display for displaying data and/or settings to the user. Such user interface can be associated with the controller and/or water heater 10, or can be a separate device that is configured to communicate with the controller 14. For example, the user interface 34 could be a display and keypad mounted to the hot water heater. Alternatively, the user interface could be a personal computer or a cell phone configured to communicate with the controller.

The controller 14 can be configured to control the hot water heater 10 so as to maximize its efficiency while still providing sufficient hot water when needed. By way of example, the controller can be configured to control the hot water heater 10 during a typical 7-day week that incorporates two showers and washing dishes:
12:00 AM-4:00 AM—Unit Off
5:00 AM-7:00 AM—Unit On, Setpoint 130 degrees (Anticipates morning showers)
7:00 AM-3:00 PM—Unit Off
3:00-7:00 PM—Unit On, Setpoint 135 degrees (Anticipates washing dinner dishes and evening shower)
7:00 PM-12:00 AM—Unit Off

In this example, the controller 14 is controlling a basic water heater by turning the heat source on and off and/or changing a setpoint temperature. More sophisticated hot water heaters, such as a GE Geospring hybrid hot water heater manufactured and sold by General Electric Corporation, may be suitable for more sophisticated control by the controller 14.

For example, the GE Geospring hybrid hot water heater utilizes an electric heat pump for heating water along with a one or more standard electric heating elements. The electric heat pump is the primary source of heat, and the one or more electric heating elements are used as supplemental heat sources in times of high hot water demand, for example, or when the heat pump alone is insufficient to heat the water. The Geospring offers several different modes of operation including an eHeat™ mode that maximizes energy efficiency by operating only the heat pump to heat the water. A hybrid mode uses less energy while still experiencing fast recovery times. In the hybrid mode, the unit uses the heat pump as its primary means to heat the water while the standard electric elements may activate if a faster water temperature recovery time is needed. Once the system determines that demand has been met, it will automatically revert back to using the heat pump only. A high demand mode is available for periods of increased hot water demand. The high demand mode operates very similar to the hybrid mode, but lets the system know in advance that it will be experiencing a larger water demand than usual. The water heater will be faster to react to temperature recovery by cycling on the heating elements sooner and for a longer duration of time. In a standard mode, the heat pump is shut off and only the electric elements are used to heat the water, similar to a standard electric water heater. Finally, a vacation mode is available. In vacation mode, the system will drop the temperature set point to 50° F. to save energy, while also preventing the water from freezing.

More sophisticated hot water heaters like the Geospring, may already incorporate a controller in the form of a microprocessor or the like for controlling the various features of the hot water heater. Such controller can thus be utilized in accordance with the present disclosure to provide scheduling features as described. By way of example, a sample schedule for a Geospring unit may resemble the following:
12:00 AM-4:00 AM—Unit Off
4:00 AM-7:00 AM—eHeat Mode, Setpoint 130 degrees (Anticipates morning showers)
7:00 AM-3:00 PM—Unit Off
3:00 PM-7:00 PM—eHeat Mode, Setpoint 135 degrees (Anticipates washing dinner dishes and evening shower)
7:00 PM-12:00 AM—Unit Off

During periods when the unit is switched off, hot water in the reservoir remains available for immediate use for at least some of the time. The length of time hot water may be available will depend in part on the amount and type of insulation surrounding the reservoir, as well as the ambient conditions in which the hot water heater is located. For example, a water heater installed in a garage would lose heat much more rapidly during winter when ambient temperatures are likely to be colder, than during the warmer summer months. Thus, a particular schedule may take into account such factors so as to ensure at least some hot water is available at all times, or the controller itself can be configured to override the schedule in the event that the water temperature in the reservoir drops below a certain point.

By scheduling the hot water heater to prepare to deliver hot water only at specified times and at specified temperatures, a consumer is given greater control over energy usage by the hot water heater. More particularly, it will be understood that heat leak during times of no hot water use can be eliminated or reduced significantly. This allows a user to avoid having to pay for energy during such non-use times.

Aspects of this invention are particularly useful for hybrid hot water heaters such as the GE Geospring mentioned previously. In such systems, the heat pump provides a much more efficient manner of heating the water and maximizing the amount of time the heat pump is run as compared to the auxiliary standard electric heating elements can result in maximum efficiency. By scheduling the hot water heater to anticipate hot water usage, the heat pump can be utilized more of the time than may otherwise be the case. For example, if usage is particularly high during the morning hours, the set point of the water can be increased and the heat pump can be operated for a longer period of time so as to reach the higher setpoint prior to water demand increasing in the morning. This has the effect of supplying additional hot water capacity without having to implement the resistive heating elements as otherwise might be the case.

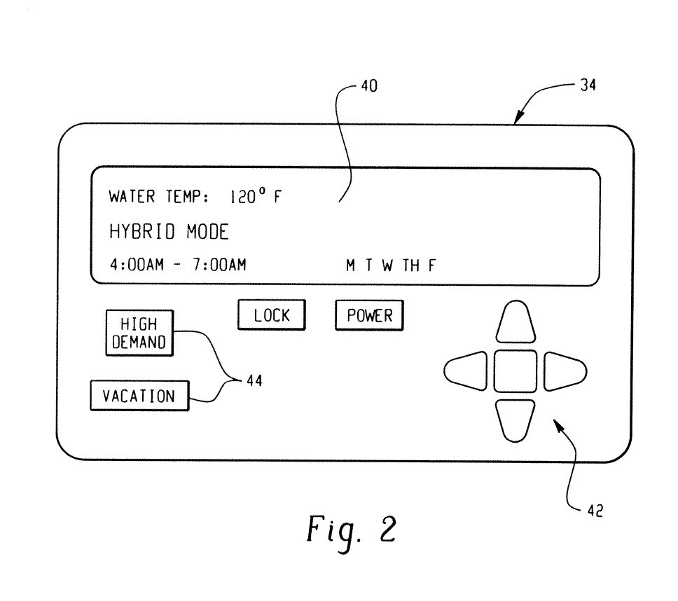

Turning to FIG. 2, an exemplary user interface 34 is illustrated. The user interface 34 may be mounted directly to the hot water heater 10 and can include a display 40 for displaying information relating to the hot water heater 10 including water temperature, mode, and schedule. A directional pad (D-pad) 42 is provided to enable a user to navigate various menus and select items in a conventional manner. A plurality of buttons 44 for selecting various features are provided, including a power button, a lock button, a high demand button, and a vacation button.

The illustrated user interface display 40 indicates that the hot water heater 10 is scheduled to operate in hybrid mode, at a water temperature set point of 120 F, between 4 am and 7 am on Mondays-Fridays. As will be appreciated, a user can use the D-pad 42 to set and review the schedule in a conventional manner. In that regard, suitable software may be provided and stored in a memory of the user interface 40.

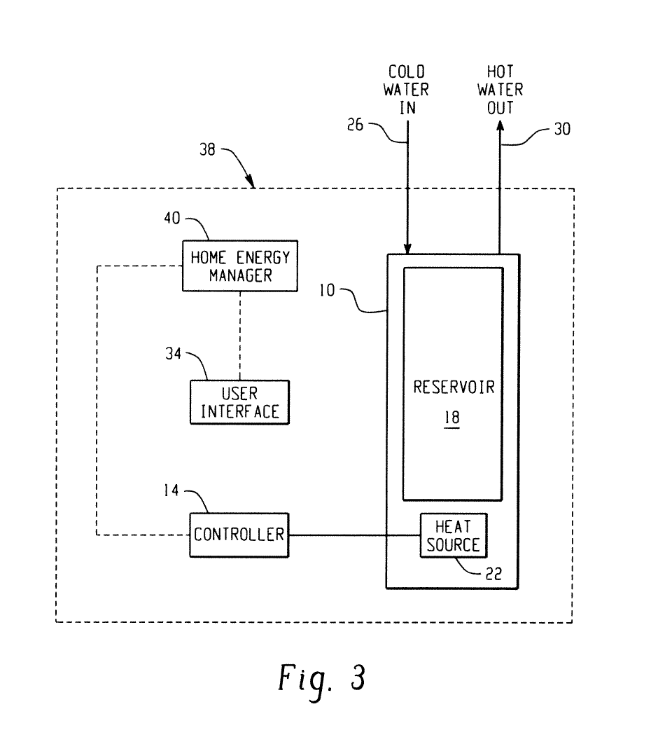

Turning to FIG. 3, the exemplary hot water heater 10 including a controller 14 is illustrated as part of home energy management system 38 that includes a home energy manager (HEM) 40. Home energy management (HEM) systems are becoming a key to reducing energy consumption in homes and buildings, in a consumer friendly manner.

Key functions of a HEM system can include:
Creates a network of energy consuming devices within the home,
Measures the consumption of the whole home/building or individual devices,
Records and stores energy consumption information in a database, and
Enables consumer interface with all energy consuming devices in a home to:
   view consumption data of individual devices
   set preferences for operation of energy consuming devices at different times during the day or at different energy pricing levels
   control/program energy consuming devices.

As will be appreciated, in FIG. 3 the home energy manager 40 is connected to the controller 14 and can be configured to communicate therewith to further control various functions of the hot water heater 10. In one embodiment, the HEM 40 simply may receive information from the controller 14 regarding scheduling of the hot water heater 10. For example, the HEM 40 may receive and/or store a schedule such as set forth previously.

Given that most HEMs 40 are associated with a user interface, it may be advantageous to provide for programming the controller via the user interface of the HEM 40, or via the HEM itself. As will be appreciated, an HEM 40 is uniquely aware of the ongoing energy usage habits of a household. For example, an HEM may collect data relating to usage of clothes washing machines, dishwashers, etc. that could impact hot water demand. As such, a HEM 40 could be configured to utilize such data to customize a user defined schedule. For example, if a given user defined schedule indicates shutting down the water heater after 7 pm, but the HEM 40 has data indicating that the dishwasher is typically operated between 9 pm and 10 pm, the HEM 40 could customize the user defined schedule to ensure ample hot water is available to run the dishwasher.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A hot water heater comprising:
a reservoir for storing water;
a heat source for selectively applying heat to the water; and
a controller for controlling the heat source to optimize energy consumption of the water heater based on demand for hot water, the controller configured to perform at least one of the following functions:
prevent the heat source from applying heat to the water during predetermined periods of time corresponding reduced demand;
activate the heat source prior to predetermined periods of increased demand;
select an operating mode; or
adjust a setpoint temperature of the water to be maintained by the application of heat by the heat source, including lowering the setpoint temperature when reduced demand is anticipated, and increasing the setpoint temperature when increased demand is anticipated.

2. A hot water heater as set forth in claim 1, wherein the controller is programmable to perform at least one of the functions at a user specified time.

3. A hot water heater as set forth in claim 1, wherein the controller is programmable to perform at least one function in accordance with a user defined schedule.

4. A hot water heater as set forth in claim 3, wherein the user defined schedule is at least one of a weekly schedule, a monthly schedule or an annual schedule.

5. A hot water heater as set forth in claim 1, further comprising a user interface for programming the controller to control the heat source.

6. A hot water heater as set forth in claim 1, wherein the heat source includes at least one of an electric heating element, a gas heating element or a heat exchanger heating element.

7. A device for controlling a heating element of a hot water heater comprising;
a controller for controlling the heat source to optimize energy consumption of the water heater based on demand for hot water, the controller configured to perform at least one of the following functions:
prevent the heat source from applying heat to the water during predetermined periods of time corresponding reduced demand;
activate the heat source prior to predetermined periods of increased demand;
select an operating mode; or
adjust a setpoint temperature of the water to be maintained by the application of heat by the heat source, including lowering the setpoint temperature when reduced demand is anticipated, and increasing the setpoint temperature when increased demand is anticipated.

8. A device as set forth in claim 7, wherein the controller is programmable to perform at least one of the functions at a user specified time.

9. A device as set forth in claim 7, wherein the controller is programmable to perform at least one function in accordance with a user defined schedule.

10. A device as set forth in claim 9, wherein the user defined schedule is at least one of a weekly schedule, a monthly schedule or an annual schedule.

11. A device as set forth in claim 7, further comprising a user interface for programming the contoller to control the heat source.

12. A device as set forth in claim 7, wherein the heat source includes at least one of an electric heating element, a gas heating element, or a heat exchanger heating element.

13. A method of optimizing operation of a hot water heater including a heating source comprising:
controlling the heat source to optimize energy consumption of the water heater based on demand for hot water, the controlling including at least one of:
preventing the heat source from applying heat to the water during predetermined periods of time corresponding reduced demand;
activating the heat source prior to predetermined periods of increased demand;
selecting an operating mode based on anticipated demand; or
adjusting a setpoint temperature of the water to be maintained by the application of heat by the heat source, including lowering the setpoint temperature when reduced demand is anticipated, and increasing the setpoint temperature when increased demand is anticipated.

14. A method as set forth in claim 13, further comprising programming the controller to perform at least one of the functions at a user specified time.

15. A method as set forth in claim 13, further comprising programming the controller to perform at least one function in accordance with a user defined schedule.

16. A method as set forth in claim 14, wherein the user defined schedule is at least one of a weekly schedule, a monthly schedule or an annual schedule.

17. A method as set forth in claim 13, further comprising programming the controller via a user interface.

18. A method as set forth in claim 13, wherein the step of controlling the heat source includes controlling a current applied to an electric heat source.

19. A method as set forth in claim 13, wherein the step of controlling the heat source includes controlling the run-time of a heat pump.
